(19) United States
(12) Patent Application Publication
(10) Pub. No.: US 2008/0187816 A1
(43) Pub. Date: Aug. 7, 2008

(54) FUEL CELL UNIT AND FUEL CELL

(75) Inventors: SHINNOSUKE KOJI, Kawasaki-shi (JP); Kentaro Nagai, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/022,590

(22) Filed: Jan. 30, 2008

(30) Foreign Application Priority Data
Feb. 6, 2007 (JP) 2007-027365
Aug. 2, 2007 (JP) 2007-202367

(51) Int. Cl. H01M 4/06

(52) U.S. Cl. 429/41

(57) ABSTRACT

There is provided a fuel cell unit including at least: a membrane electrode assembly including an electrolyte membrane and two catalyst layers sandwiching the electrolyte membrane therebetween; two gas diffusion layers sandwiching the membrane electrode assembly therebetween; an oxygen supplying layer brought into contact with one gas diffusion layer of the two gas diffusion layers; two collectors; and a seal portion, in which: the fuel cell unit has side surfaces of which a side surface parallel to a proton conductive direction of the electrolyte membrane has an opening portion provided in a part of the side surface; and a part of the one gas diffusion layer brought into contact with the oxygen supplying layer constitutes a part of an outer surface of the fuel cell unit. The fuel cell unit can enhance drainage efficiency and achieve effective supply of an oxidizer.

### BACKGROUND OF THE INVENTION

1. Field of the Invention

The present invention relates to a fuel cell unit and a fuel cell, and more particularly, to a fuel cell unit and a fuel cell having a characteristic point in a cathode-side gas diffusion layer.

2. Description of the Related Art

FIG. 12 is a schematic sectional view illustrating a passive fuel cell unit according to a related art. The passive fuel cell unit includes an electrolyte membrane with catalyst layers 4 in a middle portion thereof, and an anode-side gas diffusion layer 5 and a cathode-side gas diffusion layer 3 on outer sides of the electrolyte membrane with catalyst layers 4. An upper portion thereof illustrated in FIG. 12 is an anode to which hydrogen is supplied as a fuel and a lower portion of the fuel cell unit is a cathode to which oxygen (atmosphere) is supplied as an oxidizer. To the anode side, hydrogen is supplied. Accordingly, on the anode side, sealing is performed by a seal portion 9 so that leakage is prevented. On the other hand, a flow path 2 on the cathode side has opening portions 8 for supplying air.

The hydrogen supplied to the anode is converted into protons through oxidation reaction represented by the following formula.

H₂→2H⁺+2e⁻

The protons then pass through an electrolyte membrane to be supplied to the cathode side. The oxygen supplied from the opening portions 8 by diffusion reaches the cathode and is reacted with the protons as represented by the following formula.

1/2O₂+2H⁺+2e⁻→H₂O

An overall reaction is represented by the following formula.

H₂+1/2O₂→H₂O

Thus, water is generated. The generated water is discharged through the opening portions 8 by natural diffusion or is liquefied and remains in the gas diffusion layer 3 or the flow path 2.

In particular, the water liquefied in the gas diffusion layer 3 or the flow path 2 remains in position until being evaporated to be discharged. Accordingly, when the water is left standing, the water affects the supply of oxygen to the cathode.

In consideration to this problem, Japanese Patent Application Laid-Open No. 2002-110182 suggests that a through-hole is provided to a gas diffusion layer so that moisture remaining between a catalyst layer and a gas diffusion layer is effectively discharged.

However, even when the moisture remaining between the catalyst layer and the gas diffusion layer is effectively discharged to the outside of the gas diffusion layer, there is a risk of the moisture being condensed to aggregate in an oxygen supplying layer disposed on an outer side of the gas diffusion layer, to thereby adversely affect fuel cell performance. This is because even when a traveling speed of the moisture remaining between the catalyst layer and the gas diffusion layer is increased, a speed of discharging the moisture to the outside of the fuel cell system does not change. In view of this, there has been a strong demand for a technology for discharging the generated moisture to the outside of the fuel cell system.

### SUMMARY OF THE INVENTION

According to the present invention, there can be provided a fuel cell unit and a fuel cell, in which, in order to discharge water generated in a cathode side, a structure of a cathode-side gas diffusion layer is improved, thereby enhancing drainage efficiency and enabling effective supply of an oxidizer.

The present invention provides a fuel cell unit including: a membrane electrode assembly including an electrolyte membrane and two catalyst layers sandwiching the electrolyte membrane therebetween; two gas diffusion layers sandwiching the membrane electrode assembly therebetween; an oxygen supplying layer brought into contact with one gas diffusion layer of the two gas diffusion layers; two collectors; and a seal portion, in which: the fuel cell unit has side surfaces of which a side surface parallel to a proton conductive direction of the electrolyte membrane has an opening portion provided in a part of the side surface; and a part of the one gas diffusion layer brought into contact with the oxygen supplying layer constitutes a part of an outer surface of the fuel cell unit.

In the fuel cell unit, in a section of the fuel cell unit taken along a surface perpendicular to a plane including the opening portion and parallel to the proton conductive direction, an end portion of the one gas diffusion layer brought into contact with the oxygen supplying layer in a direction perpendicular to the plane including the opening portion can be flush with, of end portions, in the direction perpendicular to the plane including the opening portion of one of plural members brought into contact with the one gas diffusion layer, the end portion farthest from a center of the fuel cell unit in the direction perpendicular to the plane including the opening portion, or can exist on an opposite side of the center of the fuel cell unit with reference to the plane.

In the fuel cell unit, the one gas diffusion layer brought into contact with the oxygen supplying layer can include at least two regions constituting a part of the outer surface of the fuel cell unit, the two regions existing while being opposed to each other.

In the fuel cell unit, the one gas diffusion layer brought into contact with the oxygen supplying layer can include a first region and a second region, the first region including a center of the one gas diffusion layer brought into contact with the oxygen supplying layer, the second region including a region which is a part of the outer surface, the second region having a hydrophilic property relatively higher than that of the first region.

In the fuel cell unit, the second region can be hydrophilic.

In the fuel cell unit, the fuel cell unit can be supplied with an oxidizer by one of natural diffusion and natural convection.

Further, according to another aspect of the present invention, there is provided a fuel cell including a fuel cell unit stack formed of the at least two fuel cell units, which are laminated to each other.

Further, according to another aspect of the present invention, there is provided a fuel cell unit formed of a laminate structural body including, on a cathode side and an anode side of an electrolyte membrane, catalyst layers, gas diffusion layers, and electrodes, and a support member, in which a part of the gas diffusion layer on the cathode side is exposed to the outside of the laminate structural body.

The part of the gas diffusion layer on the cathode side can form a part of an outer side surface of the laminate structural body to be exposed to the atmosphere.

The part of the gas diffusion layer on the cathode side can protrude from the outer side surface of the laminate structural body to be exposed to the atmosphere.

The part of the gas diffusion layer on the cathode side protruding to the outside of the laminate structural body can be applied with a hydrophilic treatment.

The gas diffusion layer on the cathode side can be formed of at least two members, one of the two members including the part of the gas diffusion layer exposed to the outside of the laminate structural body.

An oxidizer can be supplied to the fuel cell unit by natural diffusion or natural convection.

Further, according to another aspect of the present invention, there is provided a fuel cell unit stack formed of the at least two fuel cell units laminated to each other.

Further features of the present invention will become apparent from the following description of exemplary embodiments with reference to the attached drawings.

### BRIEF DESCRIPTION OF THE DRAWINGS

FIG. 1 is a schematic view illustrating an example of a fuel cell according to Embodiment 1 of the present invention.

FIG. 2 is a schematic view illustrating an example of a fuel cell unit according to Embodiment 1 of the present invention.

FIG. 3 is a schematic view illustrating another example of the fuel cell unit according to Embodiment 1 of the present invention.

FIG. 4 is a schematic view illustrating still another example of the fuel cell unit according to Embodiment 1 of the present invention.

FIG. 5 is a schematic view illustrating yet another example of the fuel cell unit according to Embodiment 1 of the present invention.

FIG. 6 is a schematic view illustrating yet another example of the fuel cell unit according to Embodiment 1 of the present invention.

FIG. 7 is a schematic view illustrating yet another example of the fuel cell unit according to Embodiment 1 of the present invention.

FIG. 8 is a schematic view illustrating an example of a fuel cell unit according to Embodiment 2 and Example 1 of the present invention.

FIG. 9 is a schematic view illustrating an example of a fuel cell unit according to Embodiment 3 of the present invention.

FIG. 10 is a schematic view illustrating an example of a fuel cell unit according to Embodiment 4 of the present invention.

FIG. 11 is a schematic view illustrating the example of the fuel cell unit according to Embodiment 4 of the present invention.

FIG. 12 is a schematic view illustrating an embodiment of a passive fuel cell according to a related art (Comparative Example 1).

FIG. 13 is a graph of an I-V curve of a fuel cell unit, which is predicted by simulation based on Examples 1 to 3 and Comparative Example 1 of the present invention.

FIG. 14 is a schematic view illustrating a fuel cell unit according to Example 4 of the present invention.

FIG. 15 is a schematic view illustrating a fuel cell unit according to Comparative Example 2 of the present invention.

FIG. 16 is a graph illustrating performance of the fuel cell unit according to each of Example 4 and Comparative Example 2.

FIG. 17 is a schematic view illustrating a fuel cell unit according to Example 5 of the present invention.

FIG. 18 is a graph illustrating performance of the fuel cell unit according to Example 5 and Comparative Example 2 of the present invention.

### DESCRIPTION OF THE EMBODIMENTS

Hereinafter, the present invention will be described in detail.

According to the present invention, there is provided a fuel cell unit including: a membrane electrode assembly including an electrolyte membrane and two catalyst layers sandwiching the electrolyte membrane therebetween; two gas diffusion layers sandwiching the membrane electrode assembly therebetween; an oxygen supplying layer brought into contact with one gas diffusion layer of the two gas diffusion layers; two collectors; and a seal portion, in which: the fuel cell unit has side surfaces of which a side surface parallel to a proton conductive direction of the electrolyte membrane has an opening portion provided in a part of the side surface; and a part of the one gas diffusion layer brought into contact with the oxygen supplying layer constitutes a part of an outer surface of the fuel cell unit.

Hereinafter, in each of Embodiments 1 to 4, a mode example of a fuel cell unit and a fuel cell according to the present invention will be illustrated.

### Embodiment 1

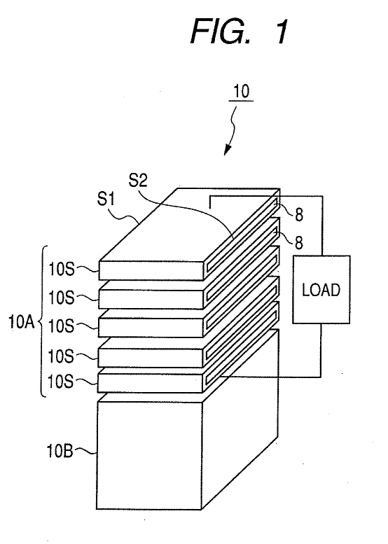

FIG. 1 is a perspective view of an overall structure of a fuel cell according to Embodiment 1 of the present invention.

As illustrated in FIG. 1, a fuel cell 10 of this embodiment includes a fuel cell unit stack (fuel cell stack) 10A in which fuel cell units (power generation cell units) 10S are stacked to be connected to each other in series. Below the cell stack 10A, a fuel tank 10B which stores a fuel gas and supplies the fuel gas to the fuel cell units 10S exists. The cell stack 10A and the fuel tank 10B are connected to each other through a flow path of the fuel gas (not shown). The fuel gas taken out from the fuel tank 10B is adjusted to have a pressure slightly higher than an atmospheric pressure and is then supplied to the fuel cell units 10S.

Of side surfaces of the fuel cell unit, in each of end surfaces S1 and S2 of the cell unit in a direction parallel to a proton conductive direction of the electrolyte membrane, the fuel cell unit 10S has the opening portion (release portion) 8. Specifically, of side surfaces, parallel to the proton conductive direction, of the oxygen supplying layer which is a component constituting the fuel cell unit 10S, each of two side surfaces is provided with the opening portion 8.

The opening portions 8 function as air inlets for taking air in the atmosphere into the fuel cell unit 10S by natural diffusion or natural convention. The opening portions 8 are not sealed, and are portions where the flow path and an external air communicate with each other. As illustrated in FIG. 1, each of the fuel cell units 10S generates power by reacting the fuel gas supplied from the fuel tank 10B with oxygen in the air taken in through the opening portions 8. Note that, in a case where the fuel cell unit has a rectangular parallelepiped shape, each of the opposing two side surfaces can be provided with the opening portion.

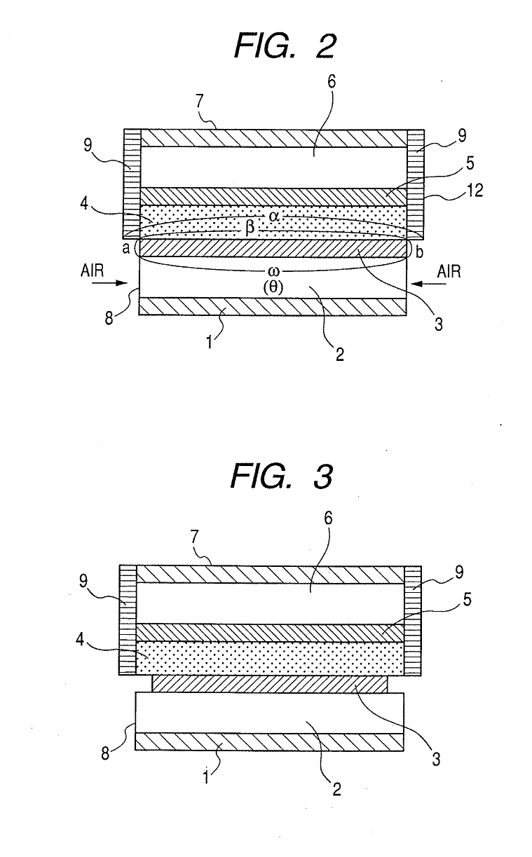

Next, an example of the fuel cell unit of this embodiment is illustrated in FIG. 2. FIG. 2 is a sectional view of the fuel cell unit of this embodiment taken along a surface perpendicular to a plane including the opening portion 8 of the fuel cell unit and parallel to the proton conductive direction.

As illustrated in FIG. 2, the fuel cell unit of this embodiment includes the anode-side gas diffusion layer 5 and the cathode-side gas diffusion layer 3 which are provided on both sides of the electrolyte membrane with catalyst layers 4, respectively, and an anode-side flow path 6 and the cathode-side flow path 2, which are provided on outer sides of those, respectively, for supplying the fuel or the oxidizer. In other words, the fuel cell unit of this embodiment includes the membrane electrode assembly 4 including the electrolyte membrane and the two catalyst layers (fuel electrode and oxygen electrode, respectively) formed while being brought into contact with both surfaces of the electrolyte membrane, respectively, the cathode-side gas diffusion layer 3 and the anode-side gas diffusion layer 5 existing while sandwiching the membrane electrode assembly, the oxygen supplying layer (cathode-side flow path) 2 existing while coming into contact with the cathode-side gas diffusion layer, and the fuel supplying layer (anode-side flow path) 6 existing while coming into contact with the anode-side gas diffusion layer, the seal portion 9, and two collectors (cathode-side collector 1 and anode-side collector 7). Note that, in the following figures, the same members as those of FIG. 2 are denoted by the same reference numerals.

Further, in FIG. 2, the fuel supplying layer 6 exists between the anode-side gas diffusion layer 5 and the anode-side collector 7. However, there may be employed a structure in which only the anode-side gas diffusion layer 5 exists and the anode-side gas diffusion layer 5 also serves as the fuel supplying layer 6.

The fuel cell unit of this embodiment has a structure in which the cathode-side gas diffusion layer 3 of the fuel cell unit constitutes a part of an outer surface (outer side surface) of the fuel cell unit. In other words, the fuel cell unit of this embodiment has a structure in which a part of the cathode-side gas diffusion layer is exposed to the atmosphere from the laminate structural body. Specifically, by removing a part of a member sealing an edge of the laminate surface of the gas diffusion layer, there may be employed a structure in which the part of the cathode-side gas diffusion layer is exposed to the atmosphere from the laminate structural body.

Further, the fuel cell unit of this embodiment has a section taken along the surface perpendicular to the plane including the opening portion 8 of the fuel cell unit and parallel to the proton conductive direction, in which a length (A) is equal to or smaller than a length (B) and a length (C) is equal to or smaller than a length (D).

In this case, the length (A) is a length from one end portion to another end portion of a portion, which is brought into contact with the membrane electrode assembly 4, of the cathode-side gas diffusion layer 3 in the section (denoted by reference symbol β in FIG. 2). Further, the length (B) is a length from one end portion to another end portion of a portion, which is brought into contact with the cathode-side gas diffusion layer 3, of the membrane electrode assembly 4 and the seal portion 9 in the section (denoted by reference symbol a in FIG. 2). Note that, in a case where, in the section, as illustrated in FIG. 2, the end portion of the seal portion 9 is flush with a contact portion of the membrane electrode assembly with respect to the cathode-side gas diffusion layer 3, the length (B) is the length from the one end portion to the other end portion of the portion, which is brought into contact with the cathode-side gas diffusion layer 3, of the membrane electrode assembly 4 and the seal portion 9. However, in a case where, as illustrated in FIG. 7, the end portion of the seal portion 9 is not flush with the contact portion, the length (B) is a length from one end portion to another end portion of a portion, which is brought into contact with the cathode-side gas diffusion layer 3, of the membrane electrode assembly 4 (denoted by reference symbol γ of FIG. 7). Further, the length (C) is a length from one end portion to another end portion of a portion, which is brought into contact with the oxygen supplying layer 2, of the cathode-side gas diffusion layer 3 in the section (denoted by reference symbol ω in FIG. 2). Further, the length (D) is a length from one end portion to another end portion of a portion, which is brought into contact with the cathode-side gas diffusion layer 3, of the oxygen supplying layer 2 in the section (denoted by reference symbol θ in FIG. 2).

A state where a part of the gas diffusion layer brought into contact with the oxygen supplying layer constitutes a part of the outer surface of the fuel cell unit means a state where the part of the gas diffusion layer brought into contact with the oxygen supplying layer constitutes a part of a region of an outermost surface in a region of the fuel cell unit. That is, in the present invention and in this embodiment of the present invention, the outer surface is the region of the outermost surface in the region of the fuel cell unit, that is, a portion which is irradiated with light when the light is applied from the outside of the fuel cell unit to the fuel cell unit.

For example, in a case where the cathode-side gas diffusion layer 3 has a rectangular parallelepiped shape, as illustrated in FIG. 2, regions a and b, which are side surfaces parallel to the plane including the opening portion 8 of the side surfaces of the rectangular parallelepiped and are opposed to each other, constitute a part of the outer surface (outer side surface) of the fuel cell unit.

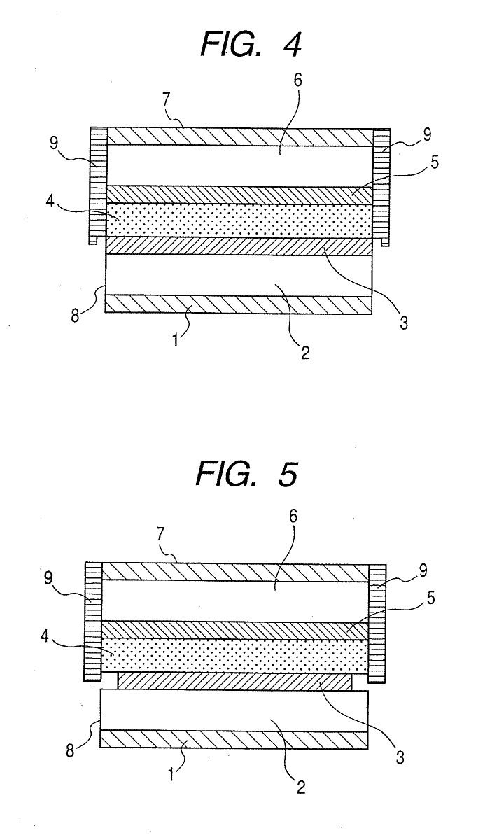

Note that the fuel cell unit of this embodiment may have a structure illustrated in FIG. 3 instead of the structure illustrated in FIG. 2.

FIG. 2 illustrates the fuel cell unit having the structure in which the length (A) is smaller than the length (B) and the length (C) is equal to the length (D).

On the other hand, FIG. 3 illustrates the fuel cell unit having a structure in which the length (A) is smaller than the length (B) and the length (C) is smaller than the length (D).

With this structure, a part of the cathode-side gas diffusion layer 3 is exposed to the atmosphere and moisture generated by power generation is directly discharged from the gas diffusion layer 3 to the atmosphere without passing through the oxygen supplying layer 2, thereby improving transpiration property.

Note that, in each of the fuel cell units having the structures of FIGS. 2 and 3, as illustrated in FIGS. 4 and 5, respectively, a part of the seal portion 9 in the vicinity of the cathode-side gas diffusion layer 3 may have an eave-like shape covering a part of the cathode-side gas diffusion layer without being in contact therewith. Even in this case, a part of the cathode-side gas diffusion layer 3 constitutes a part of the outer surface of the fuel cell unit and the part of the cathode-side gas diffusion layer 3 is exposed to the atmosphere.

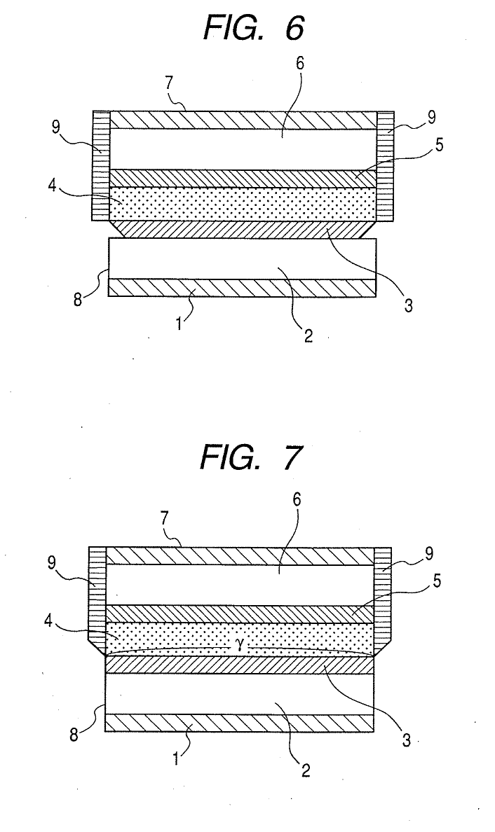

Further, as illustrated in FIG. 6, in the section, a length of the portion, which is brought into contact with the membrane electrode assembly 4, of the cathode-side gas diffusion layer 3 may be different from the length of the portion, which is brought into contact with the oxygen supplying layer 2, of the cathode-side gas diffusion layer 3.

Further, two or more fuel cell units of this embodiment can be stacked to be used as the fuel cell unit stack as illustrated in FIG. 1. In particular, in a case where the same fuel cell units are stacked to structure the fuel cell unit stack, due to the stacking of the same fuel cell units, air supply and water discharge paths are limited, so the fuel cell units of this embodiment are effectively used.

Hereinafter, with reference to FIG. 2, components constituting the fuel cell unit will be described.

The oxygen supplying layer 2 has a function of discharging water (water vapor) produced in the membrane electrode assembly 4 along with the power generation from the inside of the fuel cell unit to the atmosphere by guiding the water from the cathode-side gas diffusion layer 3 to the opening portion 8. Thus, the oxygen supplying layer 2 can be a porous body having conductivity. For the oxygen supplying layer 2 satisfying the above-mentioned conditions, a porosity can be equal to or more than 80%, and an average pore diameter can be equal to or more than 0.1 mm. As a specific material thereof, foamed metal, stainless wool, or the like can be used.

The anode-side gas diffusion layer 5 has conductivity and exists between the membrane electrode assembly 4 and the fuel supplying layer 6 while coming into contact with both the membrane electrode assembly 4 and the fuel supplying layer 6. The anode-side gas diffusion layer 5 supplies the hydrogen gas which is the fuel to the membrane electrode assembly 4 and collects electrons, which have become excessive as a result of ionization of the hydrogen, from the catalyst layer of the membrane electrode assembly 4. Note that, in a case where the fuel supplying layer 6 does not exist, the anode-side gas diffusion layer 5 comes into contact with the anode-side collector 7. The fuel gas taken out from the fuel tank 10B illustrated in FIG. 1 branches off from a main flow path of the fuel gas to be supplied to the fuel supplying layer 6 in each of the fuel cell units 10S. The fuel gas supplied to the fuel supplying layer 6 is diffused into the anode-side gas diffusion layer 5.

The cathode-side gas diffusion layer 3 exists between the membrane electrode assembly 4 and the oxygen supplying layer 2 while coming into contact with both the membrane electrode assembly 4 and the oxygen supplying layer 2. The cathode-side gas diffusion layer 3 allows oxygen to be diffused therein and functions to supply electrons required for electrode reaction in the catalyst layer (oxygen electrode) to the catalyst layer (oxygen electrode) of the membrane electrode assembly 4. Note that an average pore diameter of the gas diffusion layer 3 can be smaller than the average pore diameter of the oxygen supplying layer 2.

Further, the cathode-side gas diffusion layer 3 may include plural layers. For example, in FIG. 2, an average opening diameter of a material forming the cathode-side gas diffusion layer 3 can be in a range of 100 μm to 900 μm.

Further, the cathode-side gas diffusion layer 3 also has conductivity and is formed of a material having pores smaller than those of oxygen supplying layer 2. In the same manner, an average opening diameter of the material forming the cathode-side gas diffusion layer 3 is larger than an average opening diameter of a material forming the cathode layer serving as the oxygen electrode and is smaller than an average opening diameter of a material forming the oxygen supplying layer 2. With the above-mentioned opening diameters, the oxygen supplying layer 2 functions as restriction resistance, to thereby supply oxygen to the entire surface of the membrane electrode assembly 4 at a uniform pressure and a uniform flow rate density.

Note that, the pores of the cathode-side gas diffusion layer 3 may be through-holes communicating with the oxygen supplying layer 2 and the membrane electrode assembly 4. The cathode-side gas diffusion layer 3 has the through-holes at high density, thereby enabling the product water remaining between the membrane electrode assembly 4 and the cathode-side gas diffusion layer 3 to be sucked to the oxygen supplying layer 2. As the materials forming the cathode-side gas diffusion layer 3 and the anode-side gas diffusion layer 5, there may be used carbon paper, carbon cloth, or the like.

The membrane electrode assembly 4 includes the electrolyte membrane and the two catalyst layers (fuel electrode and oxygen electrode) formed while being brought into contact with both surfaces of the electrolyte membrane. The electrolyte membrane may be formed of any material capable of conducting protons in a direction from the fuel supplying layer 6 to the oxygen supplying layer 2. Of the electrolyte membranes, a polymer electrolyte membrane can be used. An example of the polymer electrolyte membrane includes Nafion (registered trademark) manufactured by DuPont, which is a perfluorocarbon polymer having a sulfonic acid group.

Further, each of the two catalyst layers includes at least a substance with catalytic activity. Note that, in a case where the substance with catalytic activity cannot exist as a simple substance, the catalyst layer may be formed by allowing a carrier to carry the substance with catalytic activity. As an example in which the substance with catalytic activity exists as a simple substance, there is suggested a platinum catalyst having a dendritic shape formed by a sputtering method.

On the other hand, as an example in which the carrier carries the substance with catalytic activity, there is suggested a platinum-carrying carbon particle. Note that, the catalyst layer may include an electronic conductor such as carbon particles or a proton conductor (polymer electrolyte material). The catalyst layers may be brought into contact with the surfaces of the electrolyte membrane to be integrated therewith. However, as long as the catalyst layers are brought into contact with the electrolyte membrane, and chemical species such as hydrogen ions can be delivered, the catalyst layers and the electrolyte membrane do not have to be integrated as the membrane electrode assembly 4. Further, an average opening diameter of each of the catalyst layers can be in a range of 10 nm to 100 nm. Note that, in the following specification, in some cases, the catalyst layer on the fuel supplying layer side is referred to also as the fuel electrode and the catalyst layer on the oxygen supplying layer side is referred to also as the oxygen electrode.

Each of the anode-side collector 7 and the cathode-side collector 1 has a function of collecting a current generated by the power generation. The anode-side collector 7 exists while being brought into contact with the fuel supplying layer 6. The cathode-side collector 1 exists while being brought into contact with the oxygen supplying layer 2.

The seal portion 9 has a function of retaining airtightness of the fuel electrode, thereby preventing leakage of the fuel to the outside air or preventing mixing of air into the fuel electrode. There may be used any material realizing a member having high airtightness. Various materials may be used in combination with each other. For example, sealing materials such as a gasket made of stainless steel, an aluminum alloy, or stainless steel and silicon, and an O-ring made of fluororubber may be used in combination with each other.

The fuel cell unit may have a support material. The support material has a function of retaining a structure of the fuel cell unit. The support material can be formed of a member having strength sufficient for retaining the structure. An example of the member includes stainless steel.

### Embodiment 2

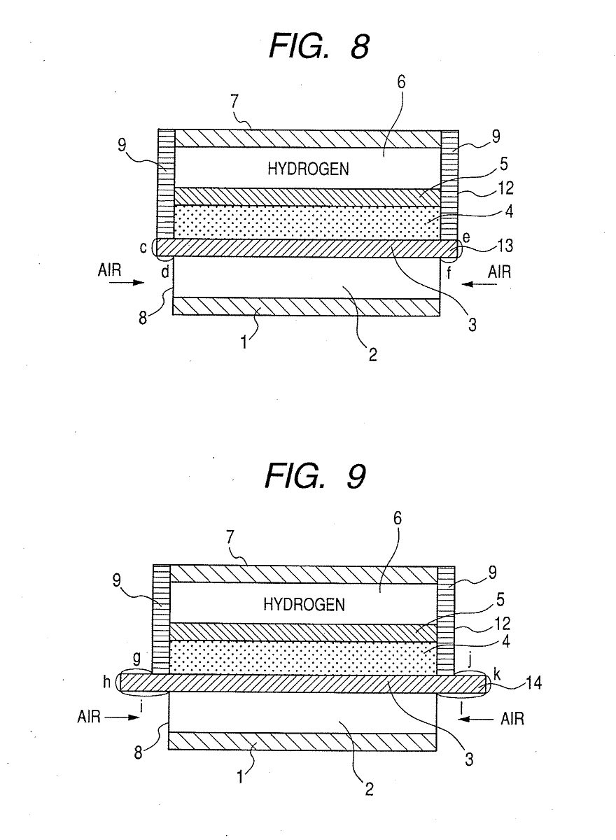

FIG. 8 is a schematic sectional view of a fuel cell unit according to this embodiment, taken along a surface perpendicular to a plane including the opening portion 8 of the fuel cell unit and parallel to a proton conductive direction.

In this embodiment, the cathode-side gas diffusion layer 3 is a part of the outer surface (outer side surface) of the fuel cell unit. Further, in the section taken along the surface perpendicular to the plane including the opening portion 8 of the fuel cell unit and parallel to the proton conductive direction, the length (A) is equal to the length (B) and the length (C) is larger than the length (D). The structure of the fuel cell unit is the same as that of Embodiment 1 except a relationship between those lengths.

For example, in a case where the cathode-side gas diffusion layer 3 has a rectangular parallelepiped shape, regions c and e which are side surfaces parallel to the plane including the opening portion 8 of side surfaces of the rectangular parallelepiped, and regions d and f which are a part of side surfaces perpendicular to the plane including the opening portion 8 and nearest to the oxygen supplying layer 2 of the side surfaces of the rectangular parallelepiped constitute a part of the outer surface (outer side surface) of the fuel cell unit.

With this structure, a part of the cathode-side gas diffusion layer 3 is exposed to the atmosphere, and moisture produced by the power generation is directly discharged from the cathode-side gas diffusion layer 3 to the atmosphere without passing through the oxygen supplying layer 2, thereby improving the transpiration property. That is, evaporation of liquid droplets remaining in the cathode-side gas diffusion layer 3 is promoted, thereby increasing efficiency of the draining.

### Embodiment 3

FIG. 9 illustrates a sectional view of a fuel cell unit of this embodiment, taken along a surface perpendicular to a plane including the opening portion 8 of the fuel cell unit and parallel to a proton conductive direction.

In this embodiment, the cathode side of the fuel cell unit is a part of the outer surface (outer side surface) of the fuel cell unit. Further, in the section along the surface perpendicular to the plane including the opening portion 8 of the fuel cell unit and parallel to the proton conductive direction, the length (A) is larger than the length (B) and the length (C) is larger than the length (D). In other words, in this structure, the cathode-side gas diffusion layer protrudes into the atmosphere. The structure of the fuel cell unit is the same as that of Embodiment 1 except a relationship between those lengths.

For example, in a case where the cathode-side gas diffusion layer 3 has a rectangular parallelepiped shape, regions h and k which are side surfaces parallel to the plane including the opening portion 8 of side surfaces of the rectangular parallelepiped, regions i and l which are a part of side surfaces perpendicular to the plane including the opening portion 8 and nearest to the oxygen supplying layer 2 of the side surfaces of the rectangular parallelepiped, and regions g and j which are a part of side surfaces perpendicular to the plane including the opening portion 8 and nearest to the membrane electrode assembly 4 of the side surfaces of the rectangular parallelepiped constitute a part of the outer surface (outer side surface) of the fuel cell unit.

In general, a function of the gas diffusion layer is to supply the fuel or the oxidizer to the catalyst layer and to collect a current generated by catalytic reaction. Accordingly, other than an effective active part of the electrolyte membrane with catalyst layers 4, portions of the gas diffusion layer exposed to the atmosphere do not directly function as described above. However, formation of those portions exposed to the atmosphere enables direct discharge of the moisture generated in the cathode to the atmosphere.

With this structure, an area exposed to the outside increases compared to Embodiments 1 and 2. Accordingly, more rapid discharge of the moisture by evaporation is enabled. A part of the cathode-side gas diffusion layer 3 is exposed to the atmosphere and the moisture generated by the power generation is directly discharged from the cathode-side gas diffusion layer 3 to the atmosphere without passing through the oxygen supplying layer 2, thereby improving transpiration property. That is, the evaporation of liquid droplets remaining in the cathode-side gas diffusion layer 3 is promoted, thereby increasing efficiency of the draining.

### Embodiment 4

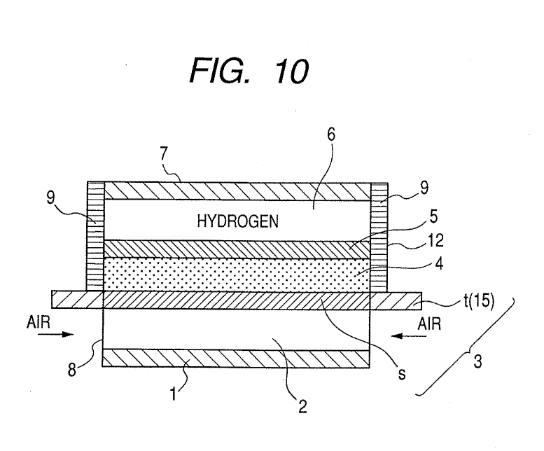

FIG. 10 illustrates a sectional view of a fuel cell unit of this embodiment, taken along a surface perpendicular to a plane including the opening portion 8 of the fuel cell unit and parallel to a proton conductive direction.

In this embodiment, the fuel cell unit according to Embodiment 3 has the following structure. In the section taken along the surface perpendicular to the plane including the opening portion 8 of the fuel cell unit and parallel to the proton conductive direction, the cathode-side gas diffusion layer is formed of at least a first portion corresponding to a region including a center of the cathode-side gas diffusion layer and a second portion including a part of the outer surface of the fuel cell unit. The second portion has relatively higher hydrophilic property than that of the first portion.

In this case, the center of the cathode-side gas diffusion layer is, in a case where the cathode-side gas diffusion layer exists as a single body, when points existing on the surface of the cathode-side gas diffusion layer are illustrated as three-dimensional coordinates, a point having an average coordinate of all the points existing on the surface of the cathode-side gas diffusion layer.

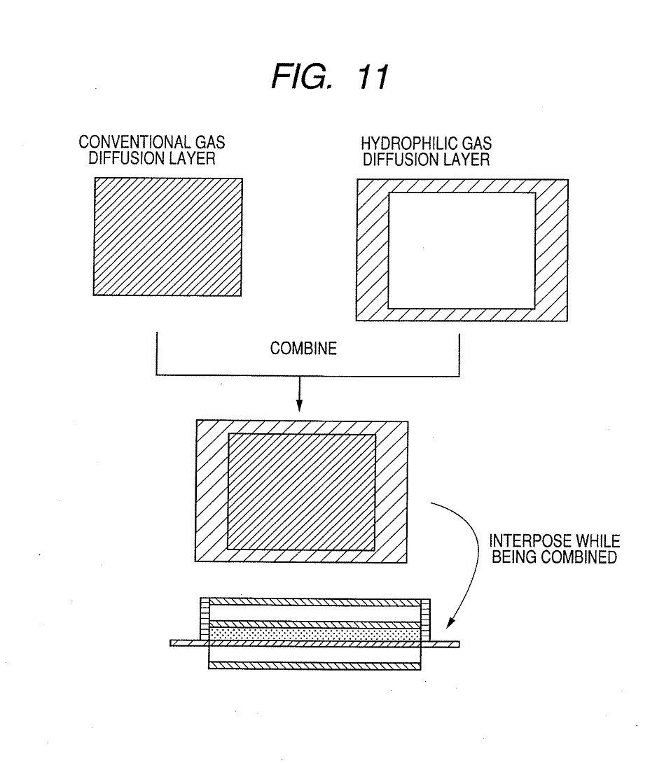

For example, as illustrated in FIG. 11, a first portion s mainly for diffusing a gas (oxygen) to membrane electrode assembly 4 and a second portion t mainly for discharging water vapor or droplets form the cathode-side gas diffusion layer 3. The first portion and the second portion t may be used by being connected in a laminate plane direction (direction perpendicular to plane including opening portion).

With this structure, water generated by the power generation is more easily discharged to the outside.

Note that the second portion t can be hydrophilic. In this case, a phrase “A is hydrophilic” means a state allowing a contact angle of water to be equal to or smaller than 90° when droplets are dropped onto the A. When the A is a porous body and hydrophilic property is extremely high, there may be a case where the A absorbs the droplets instantaneously and the contact angle cannot be measured. It is needless to say that this case is also included in the hydrophilic case.

Of the cathode-side gas diffusion layer 3, the portion (first portion s) brought into contact with an effective reaction region of the catalyst layer and the portion (second portion t) protruding into the atmosphere are different in function from each other. Accordingly, they do not have to be formed of a single member. Note that, in a case where the cathode-side gas diffusion layer is formed by using a single member, there may be used a method in which a hydrophilic treatment is applied to a portion of the cathode-side gas diffusion layer, which is desired to be made hydrophilic. In other words, in a case where the second portion t is made hydrophilic, that is, a case where a hydrophilic material is used as the second portion t, the hydrophilic material can be used as a part of the cathode-side gas diffusion layer. However, in a case where the cathode-side gas diffusion layer is formed by using a single member which is not hydrophilic, the hydrophilic treatment is applied to the portion of the second portion t to make the second portion t hydrophilic. Note that an example of the hydrophilic material include a water-absorbing material such as a water-absorbing fiber. In this case, the water-absorbing fiber refers to a fiber capable of sucking water by a capillary action, and in particular, a material whose water suction height after 10 seconds from a time when the water-absorbing fiber is soaked in the water is equal to or more than 30 mm.

Note that the fuel cell units according to Embodiments 1 to 4 also include a fuel cell unit having the following structure. In the fuel cell unit, a part of the gas diffusion layer brought into contact with the oxygen supplying layer constitutes a part of an outer surface of the fuel cell unit, and in a section of the fuel cell unit taken along a surface perpendicular to a plane including the opening portion thereof and parallel to the proton conductive direction, an end portion of the gas diffusion layer in a direction perpendicular to the plane including the opening portion is flush with, of end portions, in the direction perpendicular to the plane including the opening portion, of plural members (one of the membrane electrode assembly and the membrane electrode assembly, and the seal portion) brought into contact with the gas diffusion layer, the end portion farthest from a center of the fuel cell unit in the direction perpendicular to the plane including the opening portion. In other words, in the fuel cell unit, the part of the gas diffusion layer brought into contact with the oxygen supplying layer of the fuel cell unit constitute a part of the outer surface of the fuel cell unit. Further, the end portion of the membrane electrode assembly on the gas diffusion layer side, which is brought into contact with the gas diffusion layer, is flush with the end portion, nearest to the cathode-side gas diffusion layer, of the seal portion.

In this case, the center of the fuel cell unit is, when points existing on the outer surface of the fuel cell unit are illustrated as three-dimensional coordinates, a point having an average coordinate of all the points existing on the outer surface of the fuel cell unit.

Further, a water-absorbing layer may be provided between the collector and the oxygen supplying layer of the fuel cell unit according to each of Embodiments 1 to 4. Note that the water-absorbing layer may be formed of a water-absorbing fiber.

Further, the present invention has an effect in a case where the fuel cell units are stacked on each other as described above. In a case where the fuel cell units are stacked in a laminate direction, each of the fuel cell units takes in air only through the opening portions on the side surfaces of the fuel cell unit. For this reason, in the stack as described above, draining property of water generated in a central portion of the fuel cell unit is significantly deteriorated. In this case, by employing the structure of the present invention, the draining property can be enhanced. However, the present invention does not substantially depend on a stack shape. The above-mentioned stack structure is one of modes by which the effect of the present invention can be sufficiently exerted. However, this does not mean that the present invention relies on the stack mode.

Hereinafter, examples will be illustrated to describe the present invention in more detail.

### EXAMPLE 1

Hereinafter, a representative mode for carrying out the present invention will be described with reference to FIG. 8.

A fuel cell unit of this example includes the anode-side gas diffusion layer 5 and the cathode-side gas diffusion layer 3 provided to both sides of the electrolyte membrane with catalyst layers 4, respectively, and the fuel supplying layer 6 for supplying a fuel and the oxygen supplying layer 2 for supplying an oxidizer which are provided on the outer side of the anode-side gas diffusion layer 5 and the cathode-side gas diffusion layer 3, respectively.

The fuel cell unit of this example has, as illustrated in FIG. 8, a structure in which a part of the seal portion sealing the cathode-side gas diffusion layer 3 is removed, and a part of the cathode-side gas diffusion layer 3 forms a part of an outer side surface 12 of the laminate structural body and is exposed to the atmosphere. Note that a portion, which is exposed to the atmosphere, of the cathode-side gas diffusion layer 3 is denoted by reference numeral 13.

### EXAMPLE 2

Hereinafter, a representative mode for carrying out the present invention will be described with reference to FIG. 9.

A fuel cell unit of this example includes the anode-side gas diffusion layer 5 and the cathode-side gas diffusion layer 3 provided to both sides of the electrolyte membrane with catalyst layers 4, respectively, and the fuel supplying layer 6 for supplying a fuel and the oxygen supplying layer 2 for supplying an oxidizer which are provided on the outer side of the anode-side gas diffusion layer 5 and the cathode-side gas diffusion layer 3, respectively.

The fuel cell unit of this example has, as illustrated in FIG. 9, a structure in which a part of the seal portion sealing the cathode-side gas diffusion layer 3 is removed, and a part of the cathode-side gas diffusion layer 3 constitutes a part of an outer side surface of the laminate structural body and protrudes into the atmosphere. Note that a portion, which protrudes into the atmosphere, of the cathode-side gas diffusion layer 3 is denoted by reference numeral 14.

### EXAMPLE 3

A structure obtained by further developing Examples 1 and 2 is illustrated in FIG. 10. FIG. 10 illustrates an example in which the protruding portion of the cathode-side gas diffusion layer of the fuel cell unit illustrated in FIG. 9 is applied with a hydrophilic treatment.

The fuel cell unit of this example has, as illustrated in FIG. 10, a structure in which a part of the seal portion sealing the cathode-side gas diffusion layer 3 is removed, and a part of the cathode-side gas diffusion layer 3 constitutes a part of an outer side surface of the laminate structural body and protrudes into the atmosphere. Note that the protruding portion is applied with a hydrophilic treatment. Note that the hydrophilized portion of the cathode-side gas diffusion layer 3, protruding into the atmosphere, is denoted by reference numeral 15.

The gas diffusion layer is generally water repellent. This is because, when water generated in the gas diffusion layer remains in position for a long time, supply of the fuel or the oxidizer is inhibited. Thus, the gas diffusion layer can be water repellent so as to repel and send, when a certain amount of water remains, the water to a flow path side. However, the portion protruding into the atmosphere is not involved in a catalytic reaction of the electrolyte membrane, so the protruding portion does not have to be water repellent. The protruding portion can rather be hydrophilic to have a structure which sucks water from a portion where the catalytic reaction occurs.

As described above, of the gas diffusion layer, an original region of the gas diffusion layer, which is brought into contact with the effective reaction region of the catalyst layer, and the portion protruding into the atmosphere are different in role from each other. Accordingly, the original region and the protruding portion are not necessarily formed of a single member. For example, even with a structure including a first gas diffusion layer mainly for diffusing a gas and a second gas diffusion layer mainly for discharging water vapor or droplets, the effect of the present invention can be obtained. FIG. 11 illustrates a structural example in a case where the two gas diffusion layers are combined with each other.

(Calculation Results)

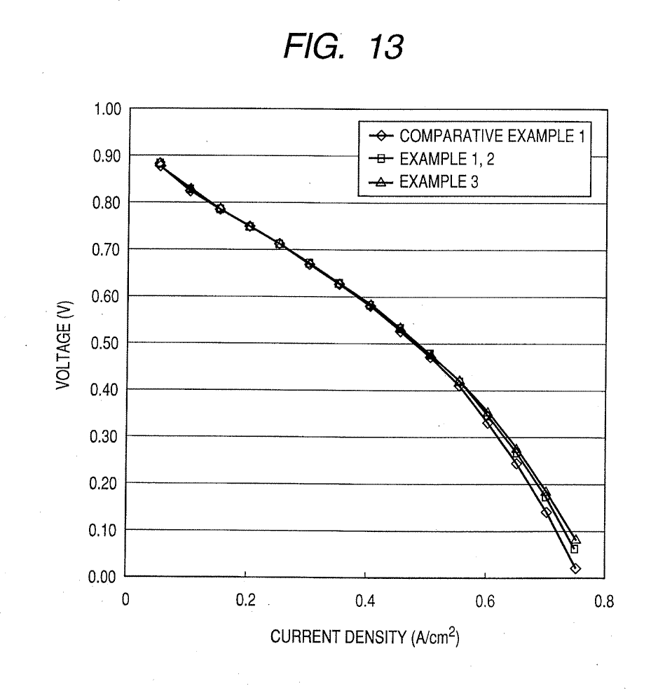

Comparisons between the above examples and a related art are plotted in FIG. 13. In this case, a difference between I-V characteristics was projected through a structural simulation by a finite element method. As a fuel cell substrate in the simulation, there was used a Nafion membrane (N112, registered trademark of DuPont) to which platinum black was adhered, thereby constituting an MEA, and with respect thereto, conditions for reproducing the catalytic reaction therein were set up. Further, as the gas diffusion layer, it was expected that carbon cloth having a porosity of 0.5 and a thickness of 0.50 mm was used. It was expected that pure hydrogen was used as the fuel gas, and oxygen was used as the oxidizer. As a result of the catalytic reaction in the cathode, oxygen is consumed, and water vapor is generated. Further, it was assumed that the water vapor was discharged from an air intake port by convection and diffusion. In addition, when an amount of the water vapor exceeds a saturated vapor amount, the water vapor is condensed to remain. The remaining droplets inhibit movement of the gas. Further, it was assumed that the droplets were moved from a hydrophobic portion to a hydrophilic portion by a capillary pressure due to hydrophilic/hydrophobic property of a porous medium.

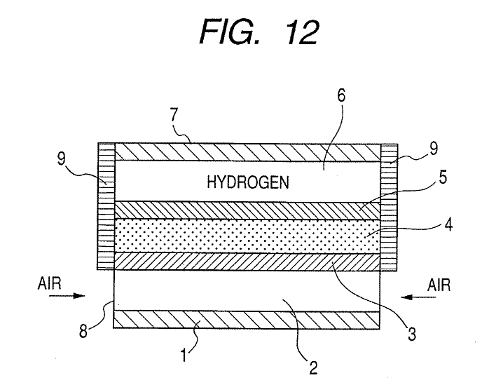

Comparative Example 1 of FIG. 13 illustrates calculation results of the related-art fuel cell (fuel cell of FIG. 12) in which the gas diffusion layer is not elongated but is fixed by a sealing agent. Examples 1 and 2 of FIG. 13 illustrate calculation results in cases where it is assumed that the gas diffusion layers according to the above Examples 1 and 2 are allowed to extend to protrude to the outside, respectively. Example 3 of FIG. 13 illustrates calculation results in a case where it is assumed that an extended portion according to the above Example 3 is applied with the hydrophilic treatment.

The results of the simulation proves that in a region where a power generation current density is low, there is no difference in I-V characteristics between the results. This is because, in the region where the power generation current density is low, little moisture is generated. However, along with the power generation current density increases, an excessive moisture is accumulated in the vicinity of the cathode. As a result, there occurs voltage reduction due to a flooding phenomenon by which supply of oxygen is inhibited. However, by the effect of the present invention, in Examples 1 and 2, the flooding is suppressed, thereby improving the I-V characteristics. This is because there appears an effect of the moisture being directly discharged to the outside through the gas diffusion layer.

In general, the gas diffusion layer has the function of supplying the fuel or the oxidizer to the catalyst layer, and has a role of collecting a current generated by the catalytic reaction. Accordingly, a portion of the gas diffusion layer other than a portion thereof brought into contact with the electrolyte membrane with catalyst layers 4 seldom performed the function. However, it is assumed that, by forming the portion exposed to the atmosphere, the moisture generated in the cathode can be directly discharged to the atmosphere, thereby enabling effective draining.

Further, in each of the following examples, a fuel cell unit is actually used to perform a fuel cell characteristics evaluation.

### EXAMPLE 4

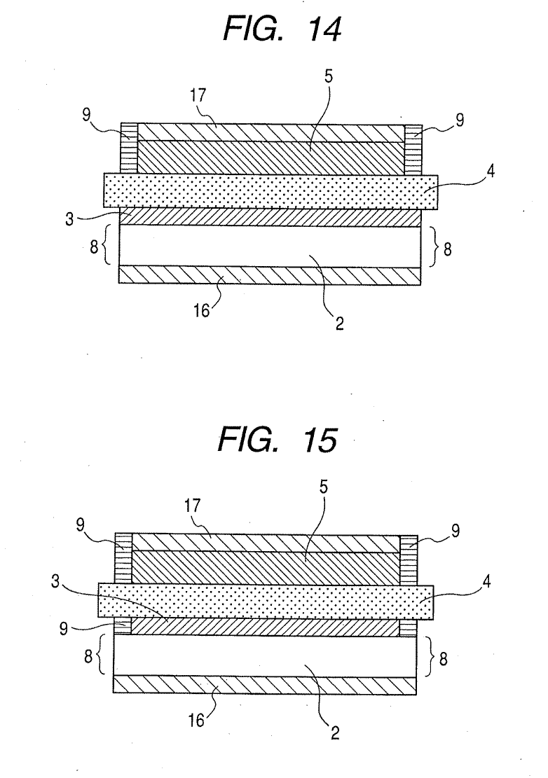

FIG. 14 illustrates a structure of a fuel cell unit used in this example.

This example is the fuel cell unit having a structure in which a part of the cathode-side gas diffusion layer is exposed to the atmosphere. In the fuel cell unit of this example, on both surfaces of the membrane electrode assembly 4, there are arranged the cathode-side gas diffusion layer 3 and the anode-side gas diffusion layer 5, respectively. The anode-side gas diffusion layer 5 also serves as the fuel supplying layer and uniformly supplies the fuel to the anode-side catalyst layer of the membrane electrode assembly. The anode side is sealed by the seal portion 9 so as to prevent the fuel from leaking to the outside. The cathode-side gas diffusion layer 3 is disposed such that the side surface thereof is exposed to the atmosphere. On the outer sides of the cathode-side gas diffusion layer 3 and the anode-side gas diffusion layer 5, there are arranged the cathode-side flow path 2 and a cathode-side collector 17, respectively.

In this example, as the cathode-side flow path 2, foamed metal (Celmet #5, manufactured by Sumitomo Electric Toyama Co., Ltd.) was used. As the cathode-side gas diffusion layer 3, carbon cloth (LT 1200-W, manufactured by E-TEK) was used. Widths of the foamed metal and the cathode-side gas diffusion layer (carbon cloth) were set to be substantially the same, thereby allowing a side surface of the carbon cloth to be exposed to the atmosphere. Further, as the anode-side gas diffusion layer 5, carbon cloth (LT 2500-W, manufactured by E-TEK) was used. Note that, a contact angle of water on a surface of the carbon cloth (LT 1200-W, manufactured by E-TEK) was about 140°.

The membrane electrode assembly was manufactured as described below. As the electrolyte membrane, a Nafion membrane (NRE-212, registered trademark of DuPont) was used. For the catalyst layer, there was used a resultant obtained by subjecting a platinum oxide having a dendritic shape obtained by a reactive sputtering method to an appropriate water repellent treatment, that is, an ionomer treatment. The catalyst layers were arranged on both surfaces of the electrolyte membrane and the resultant was hot pressed, thereby obtaining the electrolyte membrane with catalyst layers.

Hydrogen was supplied to the anode side of the fuel cell unit thus obtained in a dead-ended mode. The cathode side thereof was released to the atmosphere. In this state, under an environment in which a temperature was 25° and a humidity was 50%, the fuel cell characteristics evaluation was performed. Before the fuel cell characteristics evaluation, by an appropriate electrification treatment, reduction of the cathode-side catalyst layer of the membrane electrode assembly was performed.

### COMPARATIVE EXAMPLE 2

As Comparative Example 2 of the present invention, a fuel cell unit as illustrated in FIG. 15 was manufactured. The fuel cell unit had a structure in which the seal portion 9 was provided to the side surface of the cathode-side gas diffusion layer 3, thereby preventing the gas diffusion layer from being exposed to the atmosphere. A thickness of the seal portion 9 is the same as that of the cathode-side gas diffusion layer 3. Other members constituting the fuel cell unit were the same as those of Example 4.

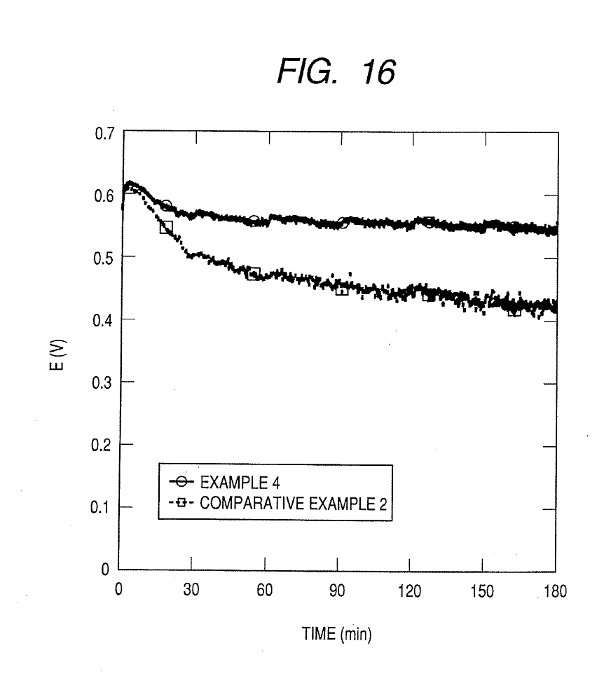

FIG. 16 illustrates results of a constant current measurement performed at a current density of 350 mA/cm² with respect to the fuel cell units according to Example 4 and Comparative Example 2. A voltage value in Comparative Example 2 gradually decreases over time. On the other hand, a voltage value in Example 4 is maintained higher than that of Comparative Example 2. This is assumed to result from such an effect that, while in the fuel cell unit according to Comparative Example 2 a product water produced on the cathode side cannot be effectively discharged, so flooding occurs, thereby causing the voltage value to gradually decrease; in Example 4, the cathode-side gas diffusion layer 3 is exposed to the atmosphere, thereby effectively discharging the product water to the outside of the fuel cell unit. A comparison was made between remaining product water amounts in the fuel cell units, each of which was calculated from a weight difference of the fuel cell unit before and after a power generation test. As a result, it was found that in Example 4, the remaining product water amount was about 20% less than that of Comparative Example 2. With reference to the results thus obtained, there is also recognized such an effect that, since the cathode-side gas diffusion layer 3 is exposed to the atmosphere, the product water is effectively discharged to the outside of the fuel cell unit.

### EXAMPLE 5

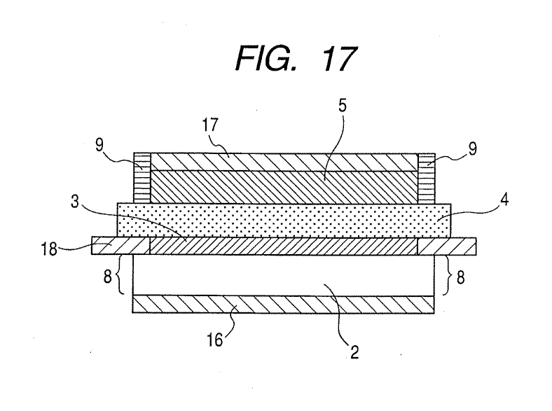

FIG. 17 illustrates a structure of a fuel cell unit according to this example.

This example illustrates the fuel cell unit having a structure in which a water-absorbing fiber having gas permeability is disposed adjacently to the cathode-side gas diffusion layer 3 and is exposed to the atmosphere. The fuel cell unit was manufactured in the same manner as in Example 1 except that a water-absorbing fiber 18 having the gas permeability was disposed adjacently to the cathode-side gas diffusion layer 3 and was exposed to the atmosphere. As the water-absorbing fiber 18 having the gas permeability, there was used a liquid diffusive non-woven cloth (P type, manufactured by AMBIC CO., LTD.) having the same thickness as that of the cathode-side gas diffusion layer 3. The water-absorbing fiber 18 was structured to have such a width that the water-absorbing fiber 18 protrudes from each of both sides of a width of the cathode-side flow path 2 by about 1 mm. Note that when water droplets were dropped onto the water-absorbing fiber 18, the water-absorbing fiber 18 instantaneously absorbed the water droplets.

Similarly to Example 4, hydrogen was supplied to the anode side of the fuel cell unit in a dead-ended mode, and the cathode side thereof was released to the atmosphere. In this state, under an environment in which a temperature was 25° and a humidity was 50%, the fuel cell characteristics evaluation was performed.

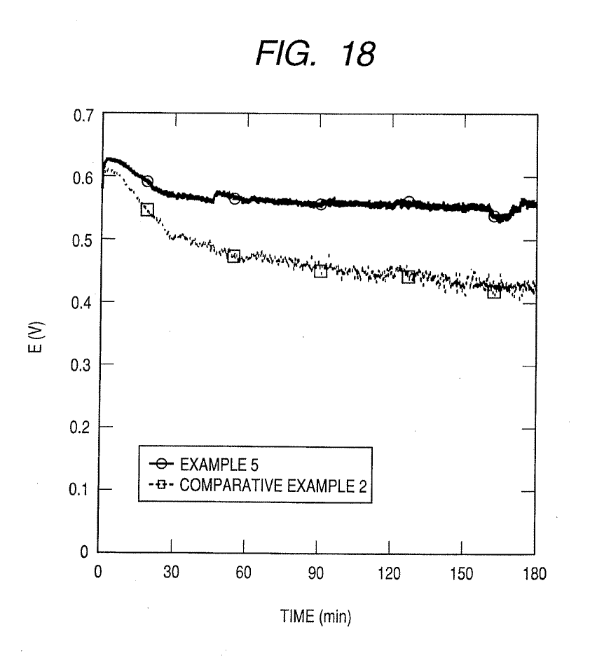

FIG. 18 illustrates results of a constant current measurement performed at a current density of 350 mA/cm² with respect to the fuel cell units according to Example 5 and Comparative Example 2. A voltage value in Comparative Example 2 gradually decreases over time. On the other hand, a voltage value in Example 5 is maintained higher than that of Comparative Example 2. This is assumed to result from such an effect that, while in Comparative Example 2 a product water produced on the cathode side cannot be effectively discharged, so flooding occurs, thereby causing the voltage value to gradually decrease; in Example 5, the product water effectively moves from the cathode-side gas diffusion layer 3 to the water-absorbing fiber 18 and the water-absorbing fiber 18 is exposed to the atmosphere, thereby effectively discharging the product water to the outside of the fuel cell unit. A comparison was made between remaining product water amounts in the fuel cell units, each of which was calculated from a weight difference of the fuel cell unit before and after a power generation test. As a result, it was found that in Example 5, the remaining product water was about 20% less than that of Comparative Example 2. With reference to the results thus obtained, there is also recognized such an effect that, since the product water is effectively moved from the cathode-side gas diffusion layer 3 to the water-absorbing fiber 18 and the water-absorbing fiber 18 is exposed to the atmosphere, the product water is effectively discharged to the outside of the fuel cell unit.

According to the present invention, by improving the structure of the gas diffusion layer, draining efficiency is enhanced, thereby enabling providing a fuel cell to which an oxidizer can be effectively supplied. Accordingly, a structure of the fuel cell can be simplified and a power generation efficiency per volume can be improved. In particular, the present invention can be utilized for designing a portable small fuel cell whose volume tends to be limited.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2007-027365, filed Feb. 6, 2007, and 2007-202367, filed Aug. 2, 2007 which are hereby incorporated by reference herein in their entirety.

What is claimed is:

1. A fuel cell unit comprising:
a membrane electrode assembly including an electrolyte membrane and two catalyst layers sandwiching the electrolyte membrane therebetween;
two gas diffusion layers sandwiching the membrane electrode assembly therebetween;
an oxygen supplying layer brought into contact with one gas diffusion layer of the two gas diffusion layers;
two collectors; and
a seal portion, wherein:
the fuel cell unit has side surfaces of which a side surface parallel to a proton conductive direction of the electrolyte membrane has an opening portion provided in a part of the side surface; and
a part of the one gas diffusion layer brought into contact with the oxygen supplying layer constitutes a part of an outer surface of the fuel cell unit.

2. The fuel cell unit according to claim 1, wherein, in a section of the fuel cell unit taken along a surface perpendicular to a plane including the opening portion and parallel to the proton conductive direction, an end portion of the one gas diffusion layer in a direction perpendicular to the plane including the opening portion is flush with, of end portions, in the direction perpendicular to the plane including the opening portion, of one of the membrane electrode assembly, and the membrane electrode assembly and the seal portion, brought into contact with the one gas diffusion layer, the end portion farthest from a center of the fuel cell unit in the direction perpendicular to the plane including the opening portion.

3. The fuel cell unit according to claim 1, wherein the one gas diffusion layer brought into contact with the oxygen supplying layer includes at least two regions constituting a part of the outer surface of the fuel cell unit, the two regions existing while being opposed to each other.

4. The fuel cell unit according to claim 1, wherein the one gas diffusion layer brought into contact with the oxygen supplying layer comprises a first region and a second region, the first region including a center of the one gas diffusion layer brought into contact with the oxygen supplying layer, the second region including a region which is a part of the outer surface, the second region having a hydrophilic property relatively higher than that of the first region.

5. The fuel cell unit according to claim 4, wherein the second region is hydrophilic.

6. The fuel cell unit according to claim 1, wherein the fuel cell unit is supplied with an oxidizer by one of natural diffusion and natural convection.

7. A fuel cell comprising a fuel cell unit stack formed of the at least two fuel cell units according to claim 1, which are laminated to each other.
